(19) United States
(12) Patent Application Publication
(10) Pub. No.: US 2013/0019728 A1
(43) Pub. Date: Jan. 24, 2013

(54) Method and apparatus for forming paired stiles and rails

(71) Applicant: Jeffrey S. Hanke, Rhinelander, WI (US)

(72) Inventor: Jeffrey S. Hanke, Rhinelander, WI (US)

(21) Appl. No.: 13/135,877

(22) Filed: Jul. 18, 2011

(51) Int. Cl. B26D 7/06

(52) U.S. Cl. 83/80

(57) ABSTRACT

The invention is for a method for making precise pairs of rails and stiles for doors and the apparatus for practicing the method. The method teaches cutting profiles into the perimeter of a workpiece and then cutting the workpiece in two to form two identical rails or stiles. The method teaches the use of a flat and true base having a flat and true fence along which a workpiece is moved into positions to cut profiles in the perimeter of the workpiece and then to cut the workpiece along its centerline into two identical rails or stiles.

### REFERENCE TO RELATED APPLICATION

This is a Continuation In Part patent application of U.S. patent application Ser. No. 12/069,407, filed Feb. 11, 2008 and which is now abandoned.

### BACKGROUND OF THE INVENTION

1. Field of the Invention

Broadly stated, this invention relates to a method and apparatus for making nearly identical pairs of wood components for cabinetry and the like.

More specifically, this invention relates to a method and apparatus for practicing a method that produces nearly identical pairs of stiles and rails for doors and the like.

In the woodworking arts, the making of fine cabinetry has long been recognized as one of the most demanding of crafts. The home building industries have evolved large housing developments which require that a large number of cabinets be produced in short periods while preserving the quality and craftsmanship of the cabinet making art.

Over decades of time, the building trades have adapted many standards and modular designs which make the economies of volume production available to the custom cabinetry business. There remains, however, an esthetic and value to a room in which the cabinetry is custom designed to fit the shape and decor of that room. For these two, somewhat conflicting reasons, the makers of custom cabinetry look at fabricating methods and apparatus in terms of both capacity for quality high speed volume production and ease of retooling for short custom runs.

2. Description of the Related Art

The building of cabinetry involves a large number of woodworking operations, many of them involving precision machining. The history of inventions that introduce new methods and apparatus into the cabinet making art is one of improving precision, speeding operations and that of sequencing and combining machining operations. These new methods and the apparatus to practice these methods often involve new technologies which are employed to facilitate the performing of old woodworking operations.

U.S. Pat. No. 1,577,744 teaches the performing of multiple cutting operations on two workpieces clamped together and carried on a conveyor that locates the workpieces relative to rotating cutting tools. The combined operations produce two workpieces that are as close to identical as the machinery of the 1920s was capable of producing.

U.S. Pat. No. 4,632,165 teaches an apparatus for performing multiple operations on a workpiece clamped in a carrier and the workpiece is moved past rotating cutting tools for some operations and rotating cutting tools are moved past the workpiece to perform other operations.

There is a limited range of cutting speeds that will produce a precise and clean profile in wood workpieces. This fact limits the potential for increasing production rates by increasing the cutting speeds of an operation. This invention overcomes that deficiency in prior art apparatus in two ways. First the apparatus is configured so that more than one workpiece can be processed by the apparatus at the same time. And, second, the last step in the method is to cut the workpiece in two to produce two identical finished pieces. Together these innovations enable the apparatus of this invention to produce at least four times the number of finished pieces then would be produced by similar prior art methods.

It also should be noted that in many door designs the rails and the stiles have the same cross sectional profile enabling the apparatus of this invention to employ the same tools and settings to cut both rails and stiles to a high degree of precision.

Unlike the precision cutting of metal, the precision cutting of wood involves different cutting speeds and feeds for cutting cross grain than are used for cutting with the grain. Prior art apparatus for making multiple cuts that involve a single drive means typically have to operate at speeds for some cuts that are less than optimum. The apparatus of this invention provides separate drives for each cutting operation which permits cutting at optimum speeds and feeds for that operation.

The making of rails (the top and bottom pieces) and stiles (the side pieces) for paneled cabinet doors requires precision in making the two opposite pieces as close to identical as is achievable, in order to achieve a perfectly square door. The inventor has advanced the art by machining the opposite pieces as a single workpiece and cutting the two pieces apart as a last step in his method.

It is therefore an object of this invention to provide a method and apparatus for cutting profiles into the perimeter edges of workpieces of the same width and thickness and of various lengths

It is further an object of this invention to provide the above described method and apparatus wherein the workpiece is advanced through the apparatus along a straight line.

It is further an object of this invention to provide the above described method and apparatus wherein the sections of the apparatus for performing each step of the method are independently driven.

It is further an object of this invention to provide the above described method and apparatus wherein more than one workpiece can be moved through the apparatus at the same time.

Other objects will become apparent from the following drawings, disclosures and claims.

### BRIEF DESCRIPTION OF THE INVENTION

This invention is for an apparatus for forming paired stiles and rails comprising:

a) an elongate rectangular base having top surface that is machined flat and true and having a longitudinal centerline and a feed end and a discharge end,

b) a fence secured along one side of the base and parallel to the longitudinal centerline of the base and having the face of the fence facing the centerline machined flat and true and the face of the fence is parallel to the centerline and perpendicular to the top surface of the base,

c) a feeder for dispensing prepared workpieces secured to the feed end of the base and adjacent to the fence,

d) a first feed apparatus for advancing a workpiece from the feeder on the base and along the fence,

e) detection apparatus positioned along the fence that detects a first end of the workpiece and cooperates with the first feed apparatus to accurately position and stop the workpiece along the fence in a first cutting position.

f) first indexing and locking apparatus for securing the workpiece in the first cutting position, secured to the base adjacent to the fence.

g) a first profiling tool secured to the base near the fence and the first profiling tool is configured to traverse the first end of the workpiece and cut a profile therein and pause at the end of the cut,

h) a second feed apparatus for receiving the workpiece from the first feed apparatus and accurately positioning a second end of the workpiece relative to the first profiling tool,

i) second indexing and locking apparatus for securing the workpiece in the second cutting position where the first profiling tool is positioned to cut a profile in the second end of the workpiece by return traversing the profiling tool across the second end of the workpiece,

k) a third feed apparatus for receiving the workpiece from the second feed apparatus for advancing the workpiece on the base and along the fence to the discharge end of the base,

l) a second profiling tool positioned along the fence and the second profiling tool is configured to cut a profile in the side edge of the workpiece adjacent to the fence,

m) a third profiling tool positioned on the base and the third profiling tool is configured to cut a profile in the side edge of the workpiece away from the fence, and

n) a cutting tool positioned on the base and cutting tool is configured to cut the workpiece along its longitudinal centerline into two nearly identical pieces

### BRIEF DESCRIPTION OF THE DRAWINGS

FIG. 1 is a pictorial view of the perimeter of a paneled door showing relationship between rails and stiles.

FIG. 2 is a fragmentary sectioned view of a rail of FIG. 1 in conjunction with a panel.

FIG. 3 is a fragmentary sectioned view of a stile of FIG. 1 in conjunction with a panel.

FIG. 4 is a schematic pictorial drawing of the apparatus employed to practice the method of this invention.

FIG. 5 is a schematic plan view of a prototype apparatus for practicing the method of this invention.

FIG. 6 is an elevation view of the apparatus of FIG. 5.

FIG. 7 is an enlarged view of the feed end of the apparatus of FIG. 5

FIG. 8 is an enlarged view of the discharge end of the apparatus of FIG. 5.

### DETAILED DESCRIPTION OF THE INVENTION

The apparatus of this invention employs mechanisms and technologies of the metal machining arts and combines them with those of the cabinet making arts to provide an apparatus that provides the precision of production machining with the craftsmanship of cabinetry. The apparatus produces pairs of nearly identical stiles and rails cut from single workpieces and separated as the last step of the machining operation. The paired stiles and rails have matched grains and colors because they are taken from the same work piece. Because the apparatus of this invention produces pairs of stiles and rails it can produce twice as many stiles and rails as equivalent prior art machines producing single stiles or rails while working at the same speeds. The profiling tools and feed apparatus are driven independently and permit more than one workpiece to be processed by the apparatus at the same time which further increases the productivity of the apparatus of this invention.

The apparatus employs a single profiling tool to cut the profiles into the end grains of both ends of the workpiece. The apparatus cuts the profile into the first end of the workpiece by traversing the end of the workpiece while it is clamped in place. The apparatus cuts the profile into the second end of the workpiece by return traversing the second end of the workpiece while it is clamped in place for the return traverse of the profiling tool. This configuration of the apparatus of this invention assures that the end cuts of the workpiece are both either power cuts or are both climb cuts made by the same tool to provide the highest degree of precision machining obtainable.

The apparatus of this invention can be converted from cutting rails to cutting stiles by disengaging the apparatus for profiling the ends of the workpiece.

In the drawings like numbers refer to like objects and the proportions of some elements have been changed to facilitate illustration. Components not essential to the disclosure of this invention such as guides, guards, power supplies, control panels, adjustments, limit switches, and the like have been omitted to simplify the drawings.

The methods and apparatus of this invention are disclosed herein as being configured to produce rails and stiles for cabinet doors. It should be understood that the apparatus can be configured to produce less demanding workpieces such as molding, trim and the like.

The term “flat and true” as used herein shall be understood to mean “a surface that is accurately machined to a smooth plane”.

The term “profiling tool” as used herein shall be understood to mean “a rotating cutter for making shaped cuts in a workpiece”.

The term “cutting position” as used herein shall be understood to mean “a location along the fence of the apparatus of this invention to which a workpiece is advanced preparatory to cutting a profile into an edge or an end of the workpiece”.

The term “climb cut” as used herein shall be understood to mean “a profiling cut wherein the rotating tool rotates into the workpiece as the cut advances”. Climb cuts are preferred when cutting with the grain.

The term “power cut” as used herein shall be understood to mean “a profiling cut wherein the rotting tool rotates out of the workpiece as the cut advances”. Power cuts are preferred when cutting cross grain.

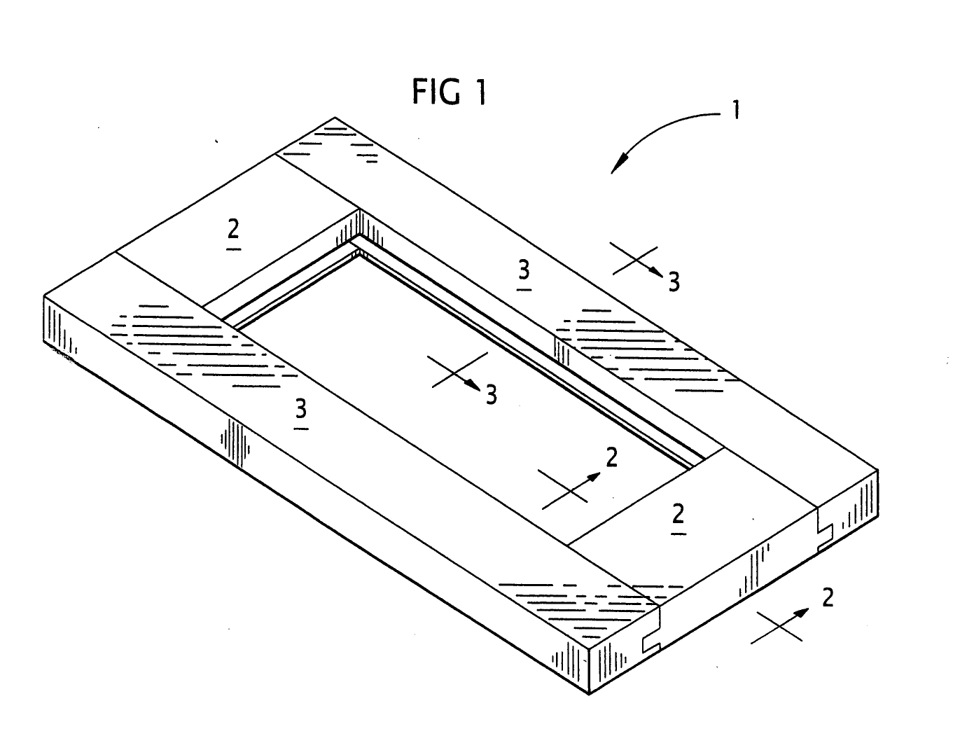

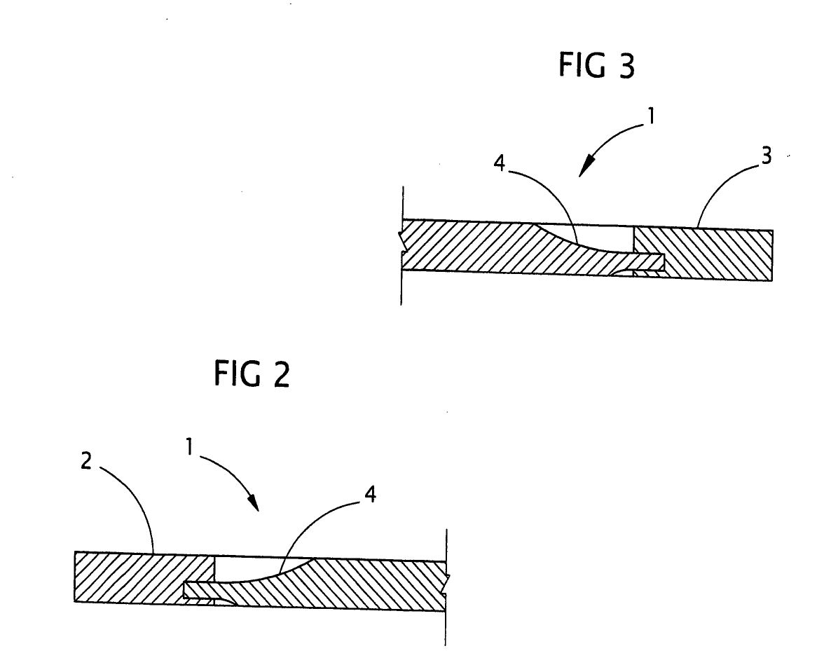

Referring now to FIGS. 1-3 which show the components of a paneled door. Paneled door 1 has rails 2 as horizontal members and stiles 3 as vertical members and door 1 has a central panel 4. In many cabinet door designs, the rails 2 and stiles 3 have the same cross sectional profile as shown in FIGS. 2 and 3. This factor permits the forming of the rails and stiles using the same machine set up for the side cuts and disconnecting the end cutting apparatus to make the stiles It should be noted that to achieve a perfectly square paneled door, the two rails and the two stiles must be nearly identical.

By using the method and apparatus of this invention pairs of rails and stiles that are identical to each other within two thousandths of an inch are obtainable.

The method of this invention involves the cutting of profiles into both sides of a workpiece and then cutting the workpiece in two, along its longitudinal centerline to create two identical pieces from the same piece of wood. The workpieces for forming the rails and stiles are cut from the same board, thereby assuring matching wood grain and width and thicknesses for both workpieces. The workpieces are provided with indicia, one to each side of their longitudinal centerlines so that when the rails and stiles are cut apart they can be brought together again in the paneled door for which they were designed. The cabinet door formed in this way will be square, dimensionally accurate, and have as closely matched wood grains as can be achieved in working with wood.

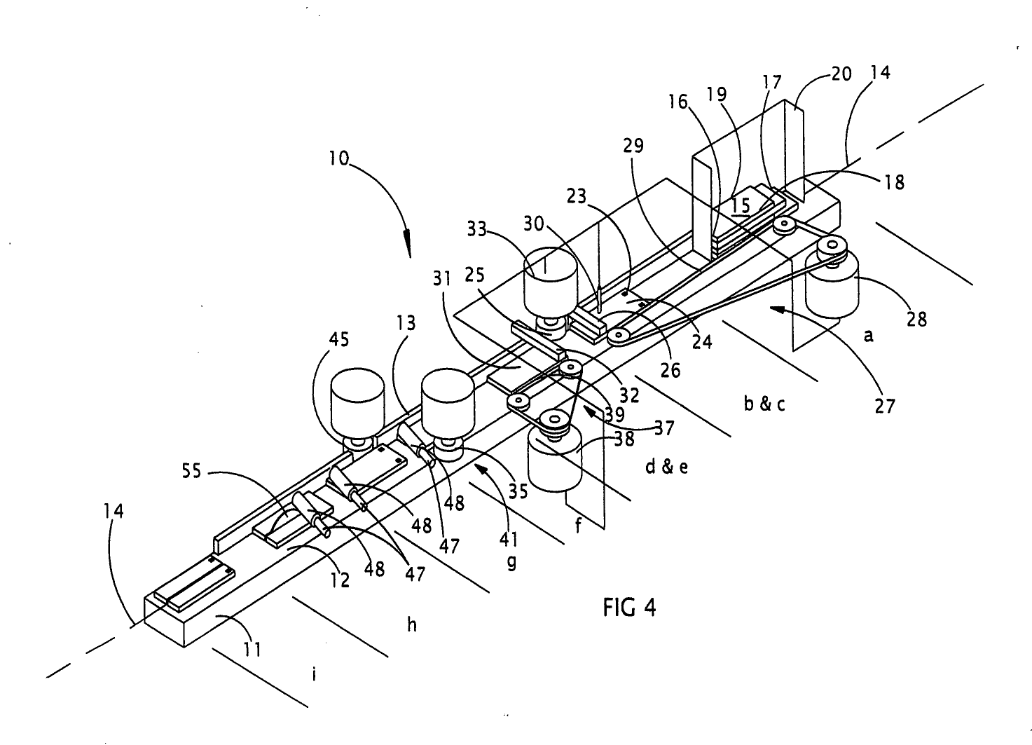

Referring now to FIG. 4 which is a schematic pictorial drawing of the apparatus 10 for practicing the method of this invention.

The method of this invention comprises the steps of:

a) preparing a supply of rectangular workpieces 15 having a first end 16, a second end 17, a first side edge 18 and a second side edge 19, and a common width and thickness and various lengths, and loading them into a feeder 20 as shown in section-a of FIG. 4,

b) advancing a workpiece 15 from the feeder 20 to a first cutting position 24 relative to a first profiling tool 25, and indexing and locking workpiece 15 in place as shown in sections-b&c of FIG. 4,

c) cutting a profile into first end 16 of workpiece 15 by traversing first profiling tool 25 across first end 16 of workpiece 15 as shown in sections-b&c of FIG. 4,

d) advancing workpiece 15 to a second cutting position 31 relative to the first profiling tool 25 and indexing and locking workpiece 15 in place, as shown in sections-d&e of FIG. 4,

e) cutting a profile into second end 17 of workpiece 15 by return traversing first profiling tool 25 across the second end 17 of workpiece 15 as shown in sections-d&e of FIG. 4,

f) cutting a profile into the first side edge 18 of workpiece 15 by advancing workpiece 15 past a second profiling tool 35 as shown in section-f of FIG. 4,

g) cutting a profile into the second side edge 19 of workpiece 15 by advancing workpiece 15 past third profiling tool 45, as shown in section-g of FIG. 4,

h) cutting workpiece 15 into two equal halves by advancing workpiece 15 across a finish cut saw 55, as shown in section-h of FIG. 4,

i) discharging from apparatus 10 two identical components of a structure as shown in section-i of FIG. 4.

FIG. 4 is a schematic pictorial representation of the apparatus 10 that is used to practice the method described above.

Apparatus 10 is assembled on a rigid base 11 which has its top surface 12 machined flat and true. Surface 12 is provided with fence 13 which is secured to one side of surface 12 and is flat and true and perpendicular to surface 12 and parallel to longitudinal centerline 14 of base 11. Workpiece 15 is moved along fence 13 and over surface 12 as it progresses through apparatus 10. Precision machining of surface 12 and fence 13 contribute to the high degree precision that is obtainable in machining workpiece 15 by the method of this invention.

The first step in the method of this invention is to prepare a supply of rectangular workpieces 15 having a first end 16, a second end 17, a first side edge 18 and a second side edge 19 a common width and thickness and various lengths, and loading them into a feeder 20 at section-a in FIG. 4. Workpieces 15 are provided with indicia 23 on each side of their centerline. Indicia 23 serve to identify the pairs of rails and stiles and to identify the assembly into which they will go.

The second step in the method of this invention is to advance the workpiece 15 from the feeder 20 to a first cutting position 24 in section-b&c in a position relative to a first profiling tool 25 and indexing and locking the workpiece in place by means of first clamping apparatus 26. Workpiece 15 is advanced from feeder 20 by first feed apparatus 27 which is shown as a friction belt 29 driven by a synchronous motor 28. As workpiece 15 is advanced by belt 29, photocell 30 detects first end 16 of workpiece 15, and causes synchronous motor 28 to position workpiece 15 in first clamping apparatus 26 with precision.

The third step in the method of this invention is to cut a profile into the first end 16 of the workpiece 15 by traversing the first profiling tool 25 across the first end 16 of workpiece 15.

First profiling tool 25 is independently driven by motor 33. It should be noted the tools that cut the profiles into the perimeter of workpiece 15 (first profiling tool 25, second profiling tool 35, third profiling tool 45 and saw 55) are each independently driven to permit the setting of the cutting speeds of the tools for an optimum quality and precision cut for each type of wood and each profile to be cut.

The fourth step in the method of this invention is to advance the workpiece 15 to a second cutting position 31 relative to first profiling tool 25 and indexing and locking the workpiece in place by means of second clamping apparatus 32 as shown in section-d&e of FIG. 4.

The fifth step in the method of this invention is to cut a profile into second end 17 of the workpiece 15 by return traversing the profiling tool 25 across second end 17 of the workpiece 15, as shown in section-d&e of FIG. 4.

It should be noted that by cutting the profile into second end 17 of workpiece 15 by return traversing first profiling tool 25. The direction of rotation of profiling tool 25 relative to the direction of travel of profiling tool 25 is made the same for both ends of workpiece 15 thereby obtaining more nearly identical cuts on both ends of workpiece 15 than would be obtainable by making the cuts on both ends with the same direction of traverse.

It should also be noted that as workpiece 15 moves from first cutting position 24 to second cutting position 31 control of workpiece 15 is transferred from first feed apparatus 27 to second feed apparatus 37. Second feed apparatus 37 has friction belt 39 which is driven by synchronous motor 38. As workpiece 15 is moving from first cutting position 24 to second cutting position 34, photocell 30 detects second end 17 of workpiece 15, and causes synchronous motor 38 to position workpiece 15 in second clamping apparatus 32 with precision.

When first profiling tool 25 reaches the end of its return traverse, workpiece 15 is released from second clamping apparatus 32 and second feed apparatus 37 advances workpiece 15 to third cutting position 41 in section-f of apparatus 10.

It should be noted that when workpiece 15 moves out of second cutting position 31 a second workpiece is advanced to first cutting position 24. In this way, two or more workpieces are being processed at the same time by apparatus 10.

It should also be noted that as workpiece 15 moves from second cutting position 31 to third cutting position 41 control of workpiece 15 is transferred from second feed apparatus 37 to third feed apparatus 47.

Third feed apparatus 47 is made up of a multiplicity of driven friction feed rollers 48. One friction feed roller 48 is shown for each cutting position for drawing clarity, but in practice, there are multiple friction feed rollers 48 bearing on workpiece 15 as it passes from cutting position to cutting position. Friction feed rollers 48 are set at an angle to fence 13 and have an axis of rotation parallel to top surface 12 which holds workpiece 15 against fence 13 and against top surface 12 as workpiece 15 passes from cutting station to cutting station.

The sixth step in the method of this invention is for third feed apparatus 47 to advance workpiece 15 past second profiling tool 35 as shown at section-f of FIG. 4.

It should be noted that after workpiece 15 leaves second cutting position 31 third feed apparatus 47 moves workpiece 15 continuously through apparatus 10 until workpiece 15 is discharged from apparatus 10 at section-i.

The seventh step in the method of this invention is for third feed apparatus 47 to advance workpiece 15 past third profiling tool 45 as shown at section-g of FIG. 4.

It should be noted that profiling tools 35 and 45 rotate in opposite directions so that the direction of rotation of both tools relative to the direction of advancement of workpiece 15 past the tools is the same for the cuts on both sides of workpiece 15 and thereby produces a more equal cut on both sides of workpiece 15 than would be obtainable if both cutting tools rotated in the same direction on both sides of workpiece 15.

The eighth step in the method of this invention is for third feed apparatus 47 to advance workpiece 15 past finish cut saw 55 as shown at section-h of FIG. 4, which cuts workpiece 15 into two very nearly identical rails.

The ninth step in the method of this invention is for third feed apparatus 47 to discharge the finished rails from apparatus 10

The above disclosures are enabling and would permit one skilled in the art to practice the method described above using the apparatus described above without undue experimentation.

However, the applicant's duty to teach the best mode known to him at the time this application for patent is being made necessitates the further disclosure of the prototype apparatus developed by the applicant.

It is possible to practice the method of this invention by employing a multiplicity of apparatuses to perform the steps of the method. The results of doing so would be less precise finished pieces made at a greater cost than what is obtainable by practicing the method of this invention on apparatus built on a single base having a top surface that is flat and true and fence that guides the workpiece in a straight line through the apparatus.

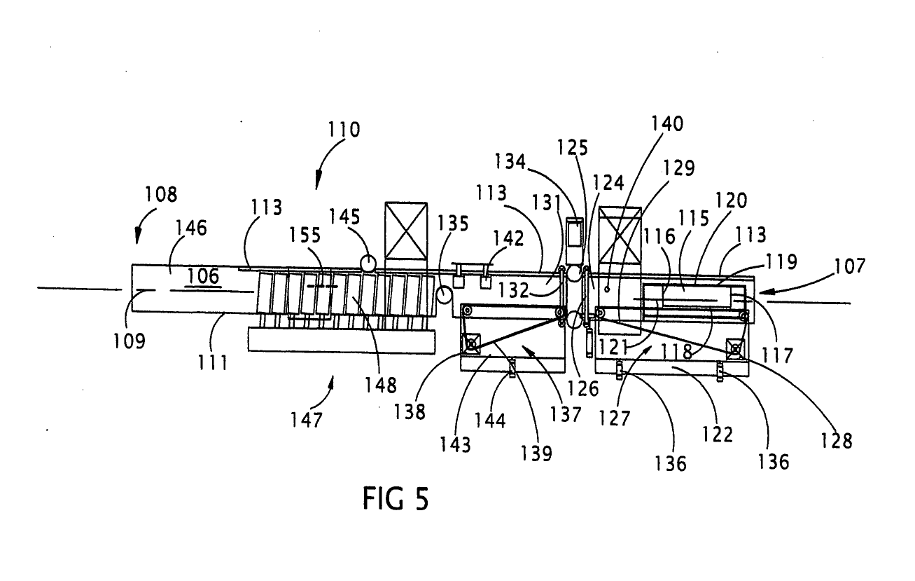

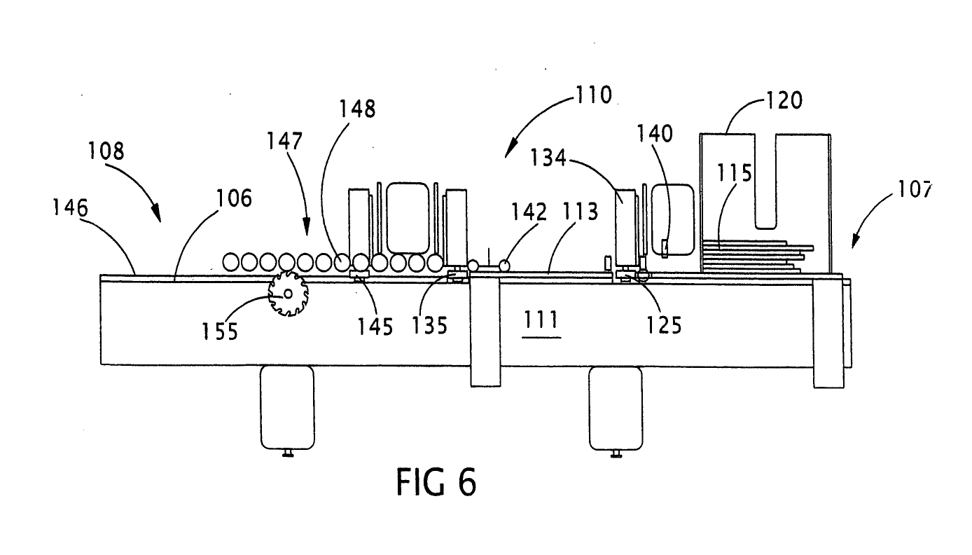

Referring now to FIGS. 5-8 wherein a prototype apparatus for practicing the method of this invention is disclosed.

The apparatus of FIGS. 5-8 is configured to make nearly identical pairs of rails and stiles with a high degree of precision by using the method described above and the apparatus described below.

Apparatus 110 comprises: a stable base 111 having a feed end 107 and a discharge end 108 and a top surface 106 that is flat and true and having a longitudinal centerline 109, and having a fence 113 that is flat and true and is fastened to one side of the top surface 106 of base 111 and perpendicular to base 111 and parallel to the longitudinal centerline 109 of base 111, a feeder 120 for dispensing workpieces 115 that have a first end 116 and a second end 117 and a first side edge 118 and a second side edge 119 and a longitudinal axis 121, and feeder 120 is located at the feed end 107 of base 111 adjacent to fence 113, and apparatus 110 further has a first feed apparatus 127 for advancing a workpiece 115 along fence 113 from feeder 120 to a first cutting position 124 to a first clamping apparatus 126 which accurately and securely positions the first end 116 of workpiece 115 relative to first profiling tool 125 and apparatus 110 further has traversing apparatus 134 for traversing the first profiling tool 125 across the first end 116 of workpiece 115 and for return traversing the profiling tool 125 across the second end 117 of workpiece 115 and the traverses are at right angles to the fence 113 and parallel to the top surface 106 of base 111, and apparatus 110 further has a second feed apparatus 137 for receiving workpiece 115 from first feed apparatus 127 and advancing workpiece 115 along fence 113 to a second cutting position 131 relative to the first profiling tool 125, and a second clamping apparatus 132 that accurately and securely positions the second end 117 of workpiece 115 relative to first profiling tool 125, and apparatus 110 further has a third feed apparatus 147 for receiving workpiece 115 from second feed apparatus 137 and advancing workpiece 115 along fence 113 past second profiling tool 135 which cuts a profile into the first side 118 of workpiece 115 and there from advances workpiece 115 along fence 113 past third profiling tool 145 which cuts a profile into the second side edge 119 of workpiece 115 and there from along fence 113 and into a saw 155 which cuts workpiece 115 along its longitudinal centerline 121 into two identical pieces and advances the workpiece 115 onto a discharge surface at the discharge end 108 of apparatus 110.

For doors in which the rails and stiles have the same cross sectional profile, the set up for cutting stiles has the same settings as those for cutting rails and first clamping apparatus 126 and second clamping apparatus 132 and first profiling tool 125 and traversing apparatus 134 are disengaged.

Apparatus 110 is configured so that workpiece 115 passes through the machine in a straight line being continuously held against top surface 106 of base 111 and against fence 113 by means of first feed apparatus 127 and second feed apparatus 137 and third feed apparatus 147 as well as idlers such as idler 142. The use of a flat and true base 111 and fence 113 along with independently driven feed apparatus 127, 137, and 147 and independently driven profiling tools 125, 135, 145 and saw 155 enables precision positioning and machining of workpiece 115 and provides apparatus 110 with the capability Of producing nearly identical cuts in workpiece 115

Further, apparatus 110 is configured so that the direction of rotation of profiling tools 125, 135, and 145 are set so that the direction of feed relative to the direction of rotation of the profiling tools is the same for both end cuts and for both side cuts. For the end cuts the same profiling tool 125 is used and the cut is made on one side of the tool and the traverse of the tool is in one direction for the first end cut and the cut is made in the opposite side of the tool and the traverse is in the opposite direction for the second end cut, thereby giving the same direction of rotation of profiling tool 125 relative to the direction of travel across both ends of workpiece 115. For the side cuts, profiling tools 135 and 145 rotate in opposite directions thereby giving the same direction of cut relative to the direction of travel of workpiece 115 past the two profiling tools.

The above disclosed methods of obtaining nearly identical cuts to both ends and both sides of workpiece 115 assure that when saw 155 cuts workpiece 115 into two equal pieces they are as nearly the same as each other as can be obtained by craftsmen practicing modern methods and using modern apparatus.

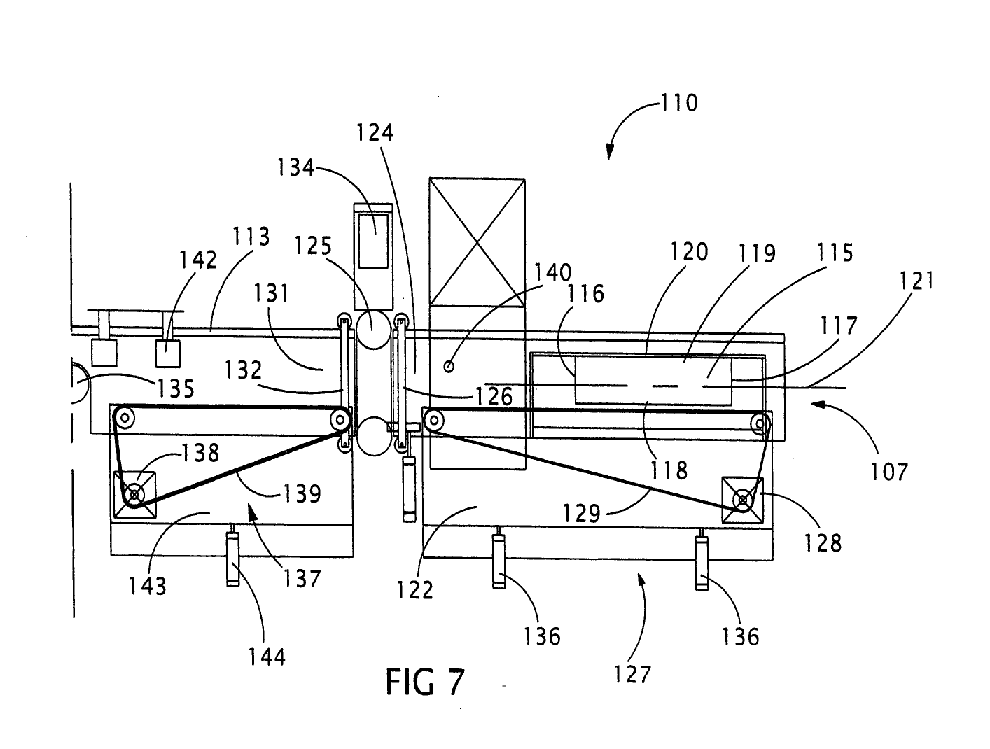

Referring now to FIG. 7 which shows the apparatus for cutting the end profiles in workpiece 115. The feed end 107 of apparatus 110 serves to perform steps a through e of the above described method by employing the shown apparatus to cut identical profiles into first end 116 and second end 117 of workpiece 115.

First feed apparatus 127 has friction belt 129 which is driven by synchronous motor 128 mounted on carrier 122. Carrier 122 is advanced towards fence 113 by mover 136 causing bottommost workpiece 115 in feeder 120 to be moved against fence 113. First feed apparatus 127 then moves workpiece 115 along fence 113 until first end 116 of workpiece 115 passes under photocell 140 which signals synchronous motor 128 to move end 116 of workpiece 115 a preset distance beyond photocell 140 and into first clamping apparatus 126. It should be noted that the combination of photocell 140, first feed apparatus 127 and synchronous motor 128 is capable of locating first end 116 of workpiece 115 within 0.002 of an inch of its intended location.

Traversing apparatus 134 then traverses first profiling tool 125 across first end 116 of workpiece 115 to cut a profile into first end 116 of workpiece 115 and stops at the end of the traverse.

First clamping apparatus 126 is then released and first feed apparatus 127 advances workpiece 115 along fence 113 and through second clamping apparatus 132 and into engagement with second feed apparatus 137. Second feed apparatus 137 has friction belt 139 which is driven by synchronous motor 138 mounted on carrier 143. Control of workpiece 115 is transferred from first feed apparatus 127 to second feed apparatus 137 by mover 144 advancing carrier 143 towards fence 113 and mover 136 retracting first feed apparatus 127. Workpiece 115 is advanced along fence 113 until second end 117 passes under photocell 140 which signals synchronous motor 138 to move second end 117 of workpiece 115 a preset distance beyond photocell 140 into second clamping apparatus 132.

With second end 117 of workpiece 115 precisely located in second clamping apparatus 132, first profiling tool 125 is return traversed across second end 117 of workpiece 115 to cut the same profile with the opposite side of first profiling tool 125 and traversing in the opposite direction as that used to cut the profile in first end 116 of workpiece 115, the profiles cut into both ends of workpiece 115 are as near to identical as modern technology can make them.

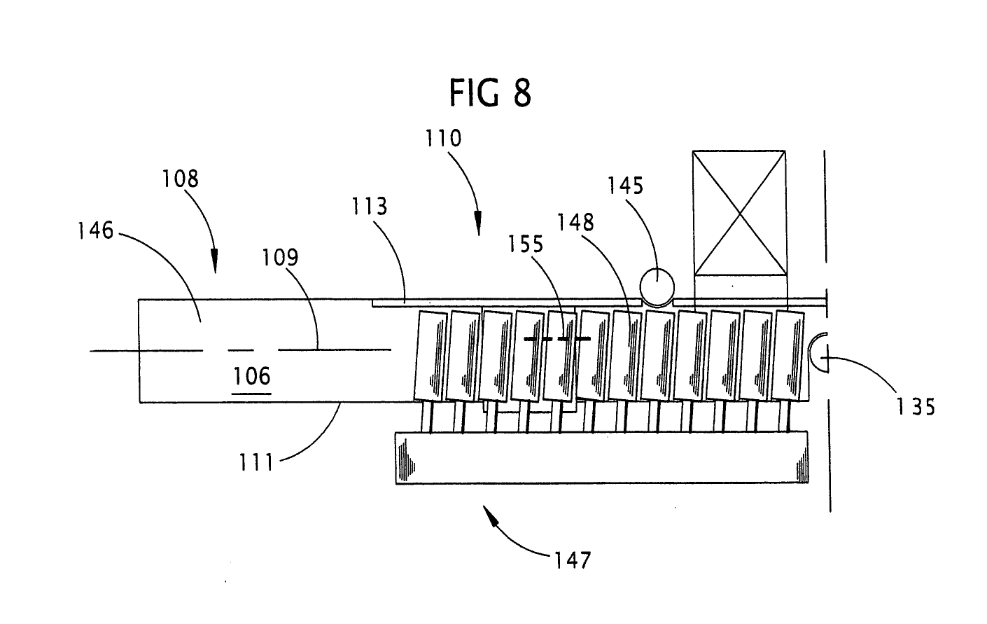

When traversing apparatus 134 is returned to its starting position, second clamping apparatus 132 is released and second feed apparatus 137 advances workpiece 115 along fence 113 and past second profiling tool 135 which cuts a profile into first side edge 118 of workpiece 115 and transfers control of workpiece 115 to third feed apparatus 147 shown in FIG. 8. First feed apparatus 127 is then free to engage a new workpiece 115 so that more than one workpiece 115 can be processed by apparatus 110 at the same time.

Referring now to FIG. 8 wherein discharge end 108 of apparatus 110 is shown and which shows the apparatus for cutting the side profiles into workpiece 115 and for cutting workpiece 115 into two very nearly identical finished pieces. The discharge end 108 of apparatus 110 serves to perform steps f through i of the above described method by employing the shown apparatus to cut identical profiles into first side edge 118 and second side edge 119 of workpiece 115 and to cut workpiece 115 into identical halves and to deliver the finished halves to a discharge surface 146 at the discharge end 108 of apparatus 110.

Control of workpiece 115 is transferred from second feed apparatus 137 to third feed apparatus 147 as workpiece 115 is moved along fence 113 past second profiling tool 135 where a profile is cut into first side edge 118 of workpiece 115. Third feed apparatus 147 has a multiplicity of driven friction feed rollers 148 which are set at an angle of approximately 85 degrees to fence 113 so that rollers 148 urge workpiece 115 against fence 113 while maintaining even contact between workpiece 115 and top surface 106 of base 111. Workpiece 115 is then moved along fence 113 past third profiling tool 145 which cuts a profile into second side edge 119 of workpiece 115. It should be noted that second profiling tool 135 and third profiling tool 145 rotate in opposite directions so that the direction that the cutting tool is moving through workpiece 115 is the same relative to the direction of movement of workpiece 115 for the cuts made on both side edges of workpiece 115.

Workpiece 115 is then moved along fence 113 past saw 115 which cuts workpiece 115 into two equal finished pieces. The two finished pieces are then delivered to delivery surface 146 of top surface 106.

The above disclosures teach the best mode of practicing the methods and making the apparatus of this invention and would enable one skilled in the art to make and use the invention for its intended purposes without undue experimentation.

It should be understood that this invention admits of numerous variations without departing from the concepts of this invention. It is therefore to be understood that the scope of this invention should not be limited to the embodiments disclosed, but the scope of this invention should only be limited by the scope of the appended claims and all equivalents thereto that would be made apparent thereby to one skilled in the art.

1-11. (canceled)

12. An apparatus for forming paired stiles and rails comprising:
a) an elongate rectangular base having top surface that is machined flat and true and having a longitudinal centerline and a feed end and a discharge end,
b) a fence secured along one side of the base and parallel to the longitudinal centerline of the base and having the face of the fence facing the centerline machined flat and true and the face of the fence is parallel to the centerline and perpendicular to the top surface of the base,
c) a feeder for dispensing prepared workpieces secured to the feed end of the base and adjacent to the fence,
d) a first feed apparatus for advancing a workpiece from the feeder on the base and along the fence,
e) detection apparatus positioned along the fence that detects a first end of the workpiece and cooperates with the first feed apparatus to accurately position and stop the workpiece along the fence in a first cutting position.
f) first indexing and locking apparatus for securing the workpiece in the first cutting position, secured to the base adjacent to the fence.
g) a first profiling tool secured to the base near the fence and the first profiling tool is configured to traverse the first end of the workpiece and cut a profile therein and pause at the end of the cut,
h) a second feed apparatus for receiving the workpiece from the first feed apparatus and accurately positioning a second end of the workpiece relative to the first profiling tool,
i) second indexing and locking apparatus for securing the workpiece in the second cutting position where the first profiling tool is positioned to cut a profile in the second end of the workpiece by return traversing the profiling tool across the second end of the workpiece,
k) a third feed apparatus for receiving the workpiece from the second feed apparatus for advancing the workpiece on the base and along the fence to the discharge end of the base,
l) a second profiling tool positioned along the fence and the second profiling tool is configured to cut a profile in the side edge of the workpiece adjacent to the fence,
m) a third profiling tool positioned on the base and the third profiling tool is configured to cut a profile in the side edge of the workpiece away from the fence, and
n) a cutting tool positioned on the base and cutting tool is configured to cut the workpiece along its longitudinal centerline into two nearly identical pieces.

13. The apparatus for forming stiles and rails of claim 1 wherein the cuts made with the grain are made by climb cuts and the cuts made across the grain are made by power cuts.

14. The apparatus for forming stiles and rails of claim 1 wherein the detection apparatus, the first indexing and locking apparatus, the first profiling tool, and the second indexing and locking apparatus are disengaged when cutting stiles.

15. The apparatus for forming stiles and rails of claim 1 wherein the feed apparatus and the profiling tools are independently driven so as to permit more than one workpiece to be processed by the apparatus of this invention at the same time.
